(19) United States
(12) Patent Application Publication
(10) Pub. No.: US 2006/0268578 A1
(43) Pub. Date: Nov. 30, 2006

(54) Light guide plate with light diffusing structure and backlight module having same

(75) Inventors: Liao-Liao Zhu, Shenzhen (CN); Yu-Liang Huang, Miao-Li (TW); Zhi-Feng Fu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/442,784

(22) Filed: May 30, 2006

(30) Foreign Application Priority Data
May 27, 2005 (TW) 94117384

(51) Int. Cl. F21V 7/04

(52) U.S. Cl. 362/618; 362/619; 362/627; 362/629

(57) ABSTRACT

An exemplary light guide plate (20) includes a transparent body (21) having a major surface (24) and a light diffusing structure (28) coated or embossed on the major surface of the transparent body. The light diffusing layer makes light beams emitting out from the light guide plate more uniform. Therefore the backlight module does not need a thick light diffusing plate. This means the backlight module is thin, assembly of the backlight module is simplified, and costs are reduced.

### FIELD OF THE INVENTION

The present invention relates to light guide plates, and to backlight modules having a light guide plate.

### GENERAL BACKGROUND

A typical liquid crystal display is capable of displaying a clear and sharp image through millions of pixels that make up the complete image. The liquid crystal display has thus been applied to various electronic equipment in which messages or pictures need to be displayed, such as mobile phones and notebook computers. However, liquid crystals in the liquid crystal display do not themselves emit light. Rather, the liquid crystals have to be lit up by a light source so as to clearly and sharply display text and images. The light source may be ambient light, or a backlight module attached to the liquid crystal display.

Referring to FIG. 3, a conventional backlight module 1 generally includes a light source 11, a reflective plate 12, a light guide plate 13, a diffusing plate 14, and a light enhancement plate 15. The reflective plate 12, the light guide plate 13, the diffusing plate 14, and the light enhancement plate 15 are arranged in that order from bottom to top. The light source 11 is positioned adjacent to a side edge of the light guide plate 13.

After light beams from the light source 11 enter the light guide plate 13, the light beams emit out from a top surface of the light guide plate 13 and enter the diffusing plate 14. The light beams are diffused to be uniform, and then enter the light enhancement plate 15. When emitting out from the light enhancement plate 15, the light beams are focused in a predetermined range of angles. Thus the light beams emitted from the backlight module 1 are uniform and have a high brightness.

However, in order to make the emitting light beams uniform, the backlight module 1 needs the diffusing plate 14. This adds to a thickness of the backlight module 1, makes assembly of the backlight module 1 relatively complicated, and makes the backlight module 1 unduly costly.

Therefore, a new light guide plate and a corresponding backlight module that can overcome the above-described problems are desired.

### SUMMARY

In a preferred embodiment, a light guide plate includes a transparent body having a major surface and a light diffusing structure coated or embossed on the major surface of the transparent body. The light diffusing layer makes light beams emitting out from the light guide plate more uniform. Therefore the backlight module does not need a thick light diffusing plate. This means the backlight module is thin, assembly of the backlight module is simplified, and costs are reduced.

Other advantages and novel features will become more apparent from the following detailed description when taken in conjunction with the accompanying drawings. All the views in the drawings are schematic.

### BRIEF DESCRIPTION OF THE DRAWINGS

FIG. 1 is an exploded, side cross-sectional view of a backlight module according a first embodiment of the present invention.

FIG. 2 is a side cross-sectional view of a light guide plate of a backlight module according a second embodiment of the present invention.

FIG. 3 is an exploded, side cross-sectional view of a conventional backlight module.

### DETAILED DESCRIPTION OF PREFERRED EMBODIMENTS

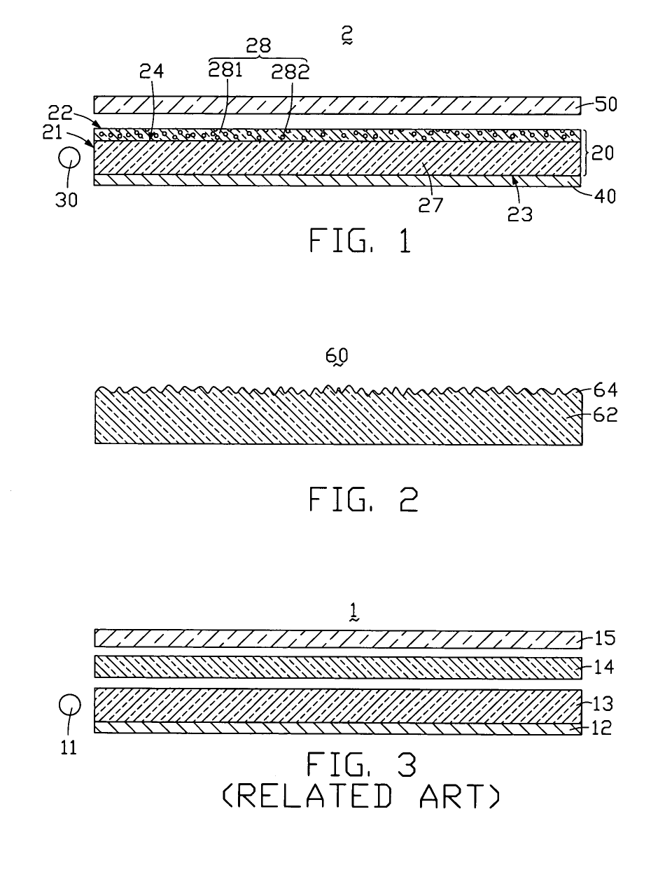

Referring to FIG. 1, a backlight module 2 according to a first embodiment of the present invention includes a light guide plate 20, a light source 30, a reflective plate 40, and a light enhancement plate 50. The reflective plate 40, the light guide plate 20, and the light enhancement plate 50 are arranged in that order from bottom to top.

The light guide plate 20 includes a body 27, and a light diffusing layer 28 coated on the body 27. The body 27 is made from a transparent material, such as polymethyl methacrylate (PMMA). The body 27 includes a light incident surface 21, a top surface 24 substantially perpendicularly adjoining the incident surface 21, and a bottom surface 23 opposite to the top surface 24. The light source 30 is disposed adjacent to the incident surface 21. The diffusing layer 28 is coated on the top surface 24 of the body 27. An upper surface 22 of the diffusing layer 28 functions as a light emitting surface of the light guide plate 20.

The diffusing layer 28 includes polymer material 281, and a plurality of diffusing particles 282 distributed in the polymer material 281. The diffusing particles 282 may be regularly or irregularly distributed in the polymer material 281. The polymer material 281 can be transparent material, such as polyethylene terephthalate (PET). The diffusing particles 282 can be made from polyethylene terephthalate or glass. The diffusing particles 282 can for example be spherical, hemispherical, or pyramidal.

The diffusing layer 28 is formed by the following steps. First, the diffusing particles 282 are formed. Second, the diffusing particles 282 are distributed into the polymer material 281. Third, the polymer material 281 with the diffusing particles 282 is coated on the top surface 24 of the body 27. The coating can be performed by way of spraying, printing, or rolling coating. In an alternative method, the polymer material 281 is firstly coated on the top surface 24 of the body 27. The polymer material 281 may for example be polyethylene terephthalate. Then the diffusing particles 282 are directly formed in the polymer material 281 by, for example, a laser process.

In summary, the light guide plate 20 includes the light diffusing layer 28 coated on the body 27 thereof. The light diffusing layer 28 makes light beams emitting out from the light guide plate 20 more uniform. Therefore the backlight module 2 does not need a thick light diffusing plate. This means the backlight module 2 is thin, assembly of the backlight module 2 is simplified, and costs are reduced.

FIG. 2 shows a light guide plate 60 of a backlight module according to a second embodiment of the present invention. The light guide plate 60 includes a body 62, and a light diffusing structure 64 integrally formed with the body 62. The body 62 is made from a transparent material, such as polymethyl methacrylate (PMMA). The diffusing structure 64 may be undulate, and may include a plurality of regularly or irregularly distributed protrusions. The diffusing structure 64 is formed by embossing a surface of the body 62, roughly polishing the body 62, or etching the surface of the body 62 with a strong acid or a strong alkali.

In summary, the light guide plate 60 includes the light diffusing structure 64 integrally formed with the body 62 thereof. The light diffusing structure 64 makes light beams emitting out from the light guide plate 60 more uniform. Therefore the backlight module does not need a thick light diffusing plate. This means the backlight module is thin, assembly of the backlight module is simplified, and costs are reduced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate comprising:
a transparent body having a major surface; and
a light diffusing structure coated or embossed on the major surface of the transparent body.

2. The light guide plate as claimed in claim 1, wherein the transparent body is made from polymethyl methacrylate.

3. The light guide plate as claimed in claim 1, wherein the light diffusing structure is undulate.

4. The light guide plate as claimed in claim 1, wherein the light diffusing structure comprises a plurality of regularly distributed diffusing particles or a plurality of regularly distributed protrusions.

5. The light guide plate as claimed in claim 1, wherein the light diffusing structure comprises a plurality of irregularly distributed diffusing particles or a plurality of irregularly distributed protrusions.

6. A backlight module comprising:
a light guide plate comprising a transparent body having a major surface and a light diffusing structure coated or embossed on the major surface of the transparent body; and
a light source adjacent to another surface of the transparent body of the light guide plate.

7. The backlight module as claimed in claim 6, wherein the transparent body is made from polymethyl methacrylate.

8. The backlight module as claimed in claim 6, wherein the light diffusing structure is undulate.

9. The backlight module as claimed in claim 6, wherein the light diffusing structure comprises a plurality of regularly distributed diffusing particles or a plurality of regularly distributed protrusions.

10. The backlight module as claimed in claim 6, wherein the light diffusing structure comprises a plurality of irregularly distributed diffusing particles or a plurality of irregularly distributed protrusions.

11. A light guide plate comprising:
a transparent body having a major surface; and
a light diffusing structure directly formed on the major surface of the transparent body before side light diffusing structure is formed with a final configuration thereof.
